(19) United States
(12) Patent Application Publication
(10) Pub. No.: US 2008/0278041 A1
(43) Pub. Date: Nov. 13, 2008

(54) Cable port for biosafety cabinet

(75) Inventors: Robert E. Lloyd, Kittery Point, ME (US); D. Aaron Johnson, Kennebunk, ME (US); Robert A. Thibeault, Sanford, ME (US); Martin S. Rogers, Saco, ME (US); Ronald W. Gingras, Sanford, ME (US); Scott R. Carpenter, Sanford, ME (US); Larry A. McCarthy, Sanford, ME (US)

Correspondence Address: LAHIVE & COCKFIELD, LLP;FLOOR 30, SUITE 3000, ONE POST OFFICE SQUARE, BOSTON, MA, 02109, US

(73) Assignee: The Baker Company, Sanford, ME (US)

(21) Appl. No.: 11/901,581

(22) Filed: Sep. 18, 2007

Related U.S. Application Data
(60) Provisional application No. 60/928,510, filed on May 10, 2007.

(51) Int. Cl. B01L 1/04

(52) U.S. Cl. 312/209; 174/650

(57) ABSTRACT

A biosafety cabinet includes at least one cable port disposed in a wall of the cabinet that allows small tubing and/or cables to enter the cabinet through the walls. The cable port eliminates problems associated with running the tubing and/or cables through an open door at the front of the cabinet. The cable ports enable the user to fully close the view screen door, while maintaining the ability to connect various tubes and/or cables to devices in the interior work area of the cabinet. The biosafety cabinet further includes a double wall configuration with negative pressure air space between the two walls. Air and byproducts or contaminants attempting to escape from the cabinet into the room or enter the cabinet from the outside environment is captured in the negative pressure area between the walls and transported directly to an air filter.

### RELATED APPLICATION

This application claims priority to, and the benefit of, co-pending U.S. Provisional Application No. 60/928,510, filed May 10, 2007, for all subject matter common to both applications. The disclosure of said provisional application is hereby incorporated by reference herein in its entirety.

### FIELD OF THE INVENTION

The present invention relates to biosafety cabinets, and more particularly to a biosafety cabinet having a cable port to provide means for running cables into the work area by maintaining contamination and clutter control.

### BACKGROUND OF THE INVENTION

A biosafety cabinet is a ventilated cabinet that uses a variety of combinations of air filters, unidirectional air flow, and containment to provide personal, product and cross contamination against particulates or aerosols from bio-hazardous agents. Conventional biosafety cabinets include one or more High Efficiency Particulate Arresting (HEPA) filters, although other types of air filters may be used as well. A HEPA filter is a type of air filter that can remove at least 99.97% of airborne particulates of 0.3 micrometres (μm) in size.

Typically, users need to run small tubing and/or cables inside the cabinet. Examples of such cables include vacuum lines, gas lines, data cables, power cords, and the like. Existing biosafety cabinets allow the tubing and/or cables to enter the cabinet through the cabinet's front work access opening by propping the door conventionally located on the front of the cabinet open and running the tubing and/or cables through the opening. This results in at least partial obstruction of the work area access opening, the potential for cables and tubing leading to the devices inside the work area 112 to be undesirably repositioned by accidental contact from a user, and alteration of the air flow dynamics of the biosafety cabinet due to the tubing and/or cables interfering with airflow at the front edge of the cabinet, among other shortcomings.

### SUMMARY

In accordance with one embodiment of the present invention, a biological safety cabinet includes a housing formed of a plurality of walls defining a chamber having an internal environment inside the chamber. The walls have a double wall configuration with an interior wall chamber between the walls. A door is disposed on one wall of the housing having an open position and a closed position. The door provides physical access to the chamber when in the open position and obstructs access to the chamber when in the closed position. A cable port is disposed in a wall of the plurality of walls defining the chamber.

The cable port includes an opening through the double wall structure that leads from an external environment through the wall chamber to the internal environment. The cable port also includes an outer flexible membrane disposed on an outside wall of the double wall structure of the housing that covers the opening and an inner flexible membrane disposed on an inside wall of the double wall structure of the housing that covers the opening. The cable port further includes at least one slit disposed in the outer flexible membrane that is configured to permit a cable to pass through the slit and the outer flexible membrane and at least one slit disposed in the inner flexible membrane that is configured to permit a cable to pass through the slit and the inner flexible membrane. The cable port substantially occludes airflow from the internal environment through to the external environment.

In accordance with various aspects of the present invention, the double wall configuration of the biosafety cabinet maintains a negative pressure air space in the wall chamber between the inner and outer wall of the double wall configuration when the cabinet is in operation.

In accordance with variations of the present invention, the biological safety cabinet includes a first ring that is disposed on the outer flexible membrane to tightly attach the outer flexible membrane to the double wall structure and a second ring that is disposed on the inner flexible membrane to tightly attach the inner flexible membrane to the double wall structure.

In accordance with various aspects of the present invention, a cable port plug is provided to cover the cable port when the cable port is not in use. A plurality of cable hooks are provided inside of the cabinet, disposed on one or more walls of the chamber. The cable hooks carry a plurality of cables.

In accordance with variations in the embodiments of the present invention, the door of the airflow bypass system may be slidably mounted within the housing. The door includes a visibility screen. The biological safety cabinet may further include a germicidal light source that generates germicidal light in the internal environment of the chamber.

In accordance with aspects of the present invention, a method of controlling contamination includes providing a biological safety cabinet and providing a cable port gasket mounted on the cable port. The cable port gasket keeps air particulates from entering the chamber. The method also includes providing a cable port plug and covering the cable port with the cable port plug when the cable port is not in use, wherein the cable port plug keeps air particulates from entering the cable port and the chamber.

### BRIEF DESCRIPTION OF THE DRAWINGS

The present invention will become better understood with reference to the following description and accompanying drawings, wherein:

FIG. 1A is a perspective view of a biosafety cabinet, in accordance with one embodiment of the present invention;

FIG. 1B is a front view of a biosafety cabinet, in accordance with one embodiment of the present invention;

FIG. 1C is a side view of a biosafety cabinet, in accordance with one embodiment of the present invention;

FIG. 2A is a close-up cutaway view of the side of the cable port mounted on one side of the biosafety cabinet;

FIG. 2B is a close-up view of a cable port gasket;

FIG. 2C is a close-up view of a cable port ring;

FIG. 3A is a perspective view of a cable port plug assembly;

FIG. 3B is a perspective view of the cable port plug assembly mounted on a cable port;

FIG. 3C is a side view of the cable port plug assembly mounted on a cable port;

FIG. 3D is a close-up cutaway view of the side of the cable port mounted on one side of the biosafety cabinet with a cable port plug assembly mounted on the cable port;

FIG. 4A is a side view of the cable hook;

FIG. 4B is a perspective view of the cable hook; and

FIG. 5 is a perspective view of the work area of the biosafety cabinet with a cable port and example cables and tubes running therethrough.

### DETAILED DESCRIPTION

An illustrative embodiment of the present invention relates to a biosafety cabinet having cable ports disposed in walls of the cabinet that allow small tubing and/or cables to enter the cabinet through the walls, eliminating problems associated with running the tubing and/or cables through an open door at the front of the cabinet. The cable ports enable the user to fully close the view screen door, while maintaining the ability to connect various tubes and/or cables and the like to devices in the interior work area of the cabinet. In accordance with one embodiment of the present invention, the biosafety cabinet has a double wall configuration with negative pressure air space between the two walls. Any contamination attempting to escape from the cabinet into the room or enter the cabinet from the outside environment is captured in the negative pressure area between the walls and transported directly to an air filter. This ensures containment of internal hazards (personal protection) as well as product protection from outside contaminants.

Prior to discussing the details of the invention, a brief overview of the different biosafety cabinets will be provided. A biological safety cabinet is designed to reduce the potential escape of airborne research or experimental materials and byproducts into the worker's environment and to remove contaminants from air entering the research work zone. A laminar flow biological safety cabinet is designed to provide three basic types of protection: personal protection from harmful agents inside the cabinet, product protection to avoid contamination of the work, experiment or process, and environmental protection from contaminants contained within the cabinet. In addition, the cabinet will provide cross contamination protection in the work zone to prevent airborne particulates from traveling from one side of the cabinet to the other side of the cabinet.

Over the years, the scientific community has adopted commonly accepted classification criteria to differentiate containment capabilities and performance attributes of biological safety cabinets. In general, biological safety cabinets are divided into 3 classifications as illustrated in Table 1.

TABLE 1

| Classification | Biosafety Level | Application |
|---|---|---|
| Class I | 1, 2, 3 | low to moderate risk biological agents |
| Class II | 1, 2, 3 | low to moderate risk biological agents |
| Class III | 4 | high risk biological agents |

Biosafety Level 1 encompasses practices, safety equipment and facilities appropriate for work with defined and characterized strains of viable microorganisms not known to cause disease in healthy adult humans. Work is generally conducted on open bench tops using standard microbiological practices. For biosafety level 1, special containment equipment or facility design is neither required nor generally used.

Biosafety Level 2 encompasses practices, safety equipment and facilities appropriate for work done with a broad spectrum of indigenous moderate-risk agents present in the community and associated with human disease in varying severity. It differs from biosafety level 1 in that laboratory personnel have specific training in handling pathogenic agents and are directed by competent scientists; access to the laboratory is limited when work is being conducted; extreme precautions are taken with contaminated sharp items; and certain procedures in which infectious aerosols or splashes may be created are conducted in biosafety cabinets or other physical containment equipment. A Class I or Class II biosafety cabinet is recommended for work involving these agents.

Biosafety Level 3 encompasses practices, safety equipment and facilities appropriate for work done with indigenous or exotic agents with a potential for respiratory transmission that may cause serious and potentially lethal infection. More emphasis is placed on primary and secondary barriers to protect personnel in the contagious area, the community, and the environment from exposure to potentially infectious aerosols. A Class I or Class II biosafety cabinet is required for work involving these agents.

Biosafety Level 4 encompasses practices, safety equipment and facilities appropriate for work done with dangerous and exotic agents that pose a high risk of life threatening disease. Agents may be transmitted via the aerosol route, and for which there is no available vaccine or therapy. Access to the laboratory is strictly controlled by the laboratory director. The facility is either in a separate building or in a controlled area within a building, which is completely isolated from all other areas of the building. A Class III biosafety cabinet or pressurized environmental suit is required for work involving these agents.

The Class I cabinet has the most basic and rudimentary design of all biosafety cabinets. A stream of inward air moving into the cabinet contains aerosols generated during microbiological manipulations. It then passes through a filtration system that traps all airborne particulates and contaminants. Finally, clean, filtered air is exhausted from the cabinet. The filtration system usually consists of a pre-filter and a HEPA (High Efficiency Particulate Air) filter.

Although the Class I cabinet protects the operator and the environment from exposure to biohazards, it does not prevent samples being handled in the cabinet from coming into contact with airborne contaminants that may be present in room air. Naturally, there is a possibility of cross-contamination that may affect experimental consistency. Class I biosafety cabinets are suitable for work with microbiological agents assigned to biological safety levels 1, 2 and 3.

Like Class I biosafety cabinets, Class II biosafety cabinets have a stream of inward air moving into the cabinet. This is known as the inflow and it prevents the aerosol generated during microbiological manipulations to escape through the front opening. However, unlike Class I cabinets, the inflow on Class II cabinets flows through the front inlet grille, near the operator. None of the unfiltered inflow air enters the work zone of the cabinet, so the product inside the work zone is not contaminated by the outside air.

A feature unique to Class II cabinets is a vertical laminar (unidirectional) HEPA-filtered air stream that descends downward from the interior of the cabinet. This continuously flushes the cabinet interior of airborne contaminants and protects samples being handled within the cabinet from contamination and is known as the down flow. Some cabinets may exhaust air directly back to the laboratory, while others may exhaust air through a dedicated ductwork system to the external environment.

Class II cabinets, like Class I cabinets, protect both the operator and environment from exposure to biohazards. In addition, Class II cabinets also protect product samples from contamination during microbiological manipulations within the cabinet interior and are all suitable for work with agents assigned to biological safety levels 1, 2 and 3. Class II cabinets are further classified according to how they exhaust air.

The Class II Type A biosafety cabinets exhaust air directly back to the laboratory, and they may contain positive pressure contaminated plenums. When toxic chemicals must be employed as an adjunct to microbiological processes, these cabinets are not used. Exhaust HEPA filtration only removes airborne aerosols including biohazards, and not chemical fumes.

The main difference between Class II type A and type B cabinets is that the type B cabinets must be operated with an external blower and it exhausts air to the external environment via a dedicated ductwork system. Without the external blower, the cabinet's internal blower will blow the air (and microbiological agents) inside the work zone through the front operator, towards the operators face, creating a dangerous situation.

The Class II Type B1 biosafety cabinets have a dedicated exhaust feature that eliminates re-circulation when work is performed towards the back within the interior of the cabinet.

In the Class II Type B2 cabinet all inflow and down flow air is exhausted after HEPA filtration to the external environment without recirculation within the cabinet. Type B2 cabinets are suitable for work with toxic chemicals employed as an adjunct to microbiological processes since no re-circulation occurs.

The Class III biosafety cabinet provides an absolute level of safety, which cannot be attained with Class I and Class II cabinets. Class III cabinets are usually of welded metal construction and are designed to be gastight. Work is performed through glove ports in the front of the cabinet. During routine operation, negative pressure relative to the ambient environment is maintained within the cabinet. This provides an additional fail-safe mechanism in case physical containment is compromised.

On Class III cabinets, a supply of HEPA filtered air provides product protection and prevents cross contamination of samples. Double HEPA filtered exhaust air may be incinerated. Class III cabinets exhaust air via a dedicated ductwork system to the external environment. When a dedicated ductwork system is employed, they are also suitable for work employing toxic chemicals as an adjunct to microbiological processes. Class III biosafety cabinets are frequently specified for work involving the most lethal biological hazards.

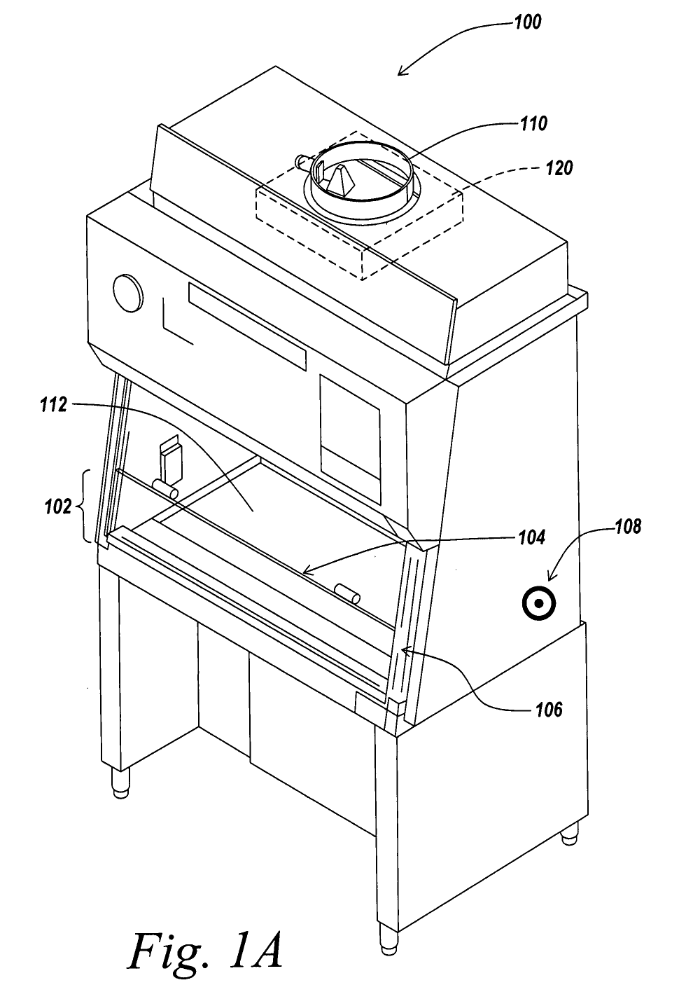

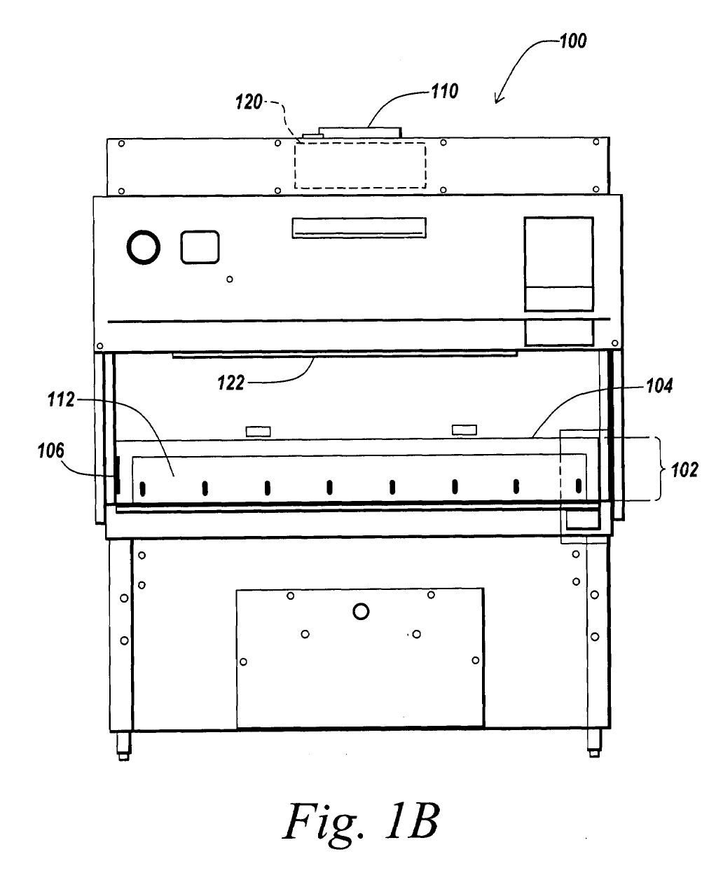

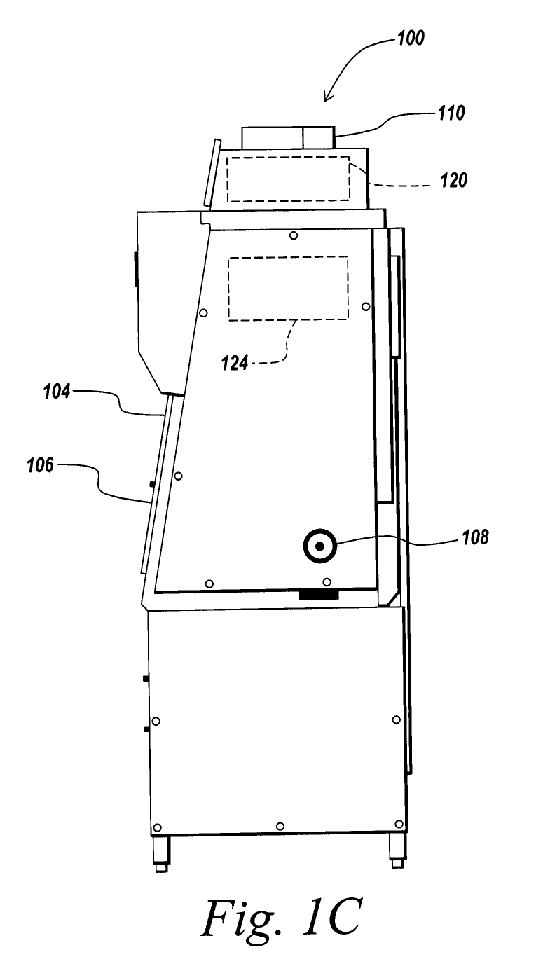

Now turning to the present invention, FIGS. 1A through 5, wherein like parts are designated by like reference numerals throughout, illustrate an example embodiment of a biosafety cabinet with cable ports in accordance with the present invention. Although the present invention will be described with reference to the example embodiment illustrated in the figures, it should be understood that many alternative forms can embody the present invention. One of ordinary skill in the art will additionally appreciate different ways to alter the parameters of the embodiment disclosed, such as the size, shape, or type of elements or materials, in a manner still in keeping with the spirit and scope of the present invention.

FIGS. 1A-1C illustrate a biosafety cabinet 100 in accordance with one embodiment of the present invention. The biosafety cabinet 100 has a view screen 104 and a work access opening 102 provided below the view screen 104. In addition, a door 106 is provided in the view screen 104 area. When the door 106 is open, the user gains physical access to a work area 112 through the work access opening 102. The biosafety cabinet 100 has an optional germicidal light source 122. The germicidal light source 122 generates germicidal light when the door 106 is closed. The generation of germicidal light may be automatically interrupted when the door 106 is opened. The germicidal light source 122 is illustrated on the upper side of the work area 112. However, it may also be provided on other locations based on the particular use and configuration of the biosafety cabinet 100. The biosafety cabinet 100 has one or more cable ports 108 on the side wall of the cabinet 100. The cable ports 108 may be provided on one side wall, on both side walls, on the back wall, and/or any double wall location of the biosafety cabinet 100. The biosafety cabinet 100 further includes an exhaust system 110 to exhaust the contaminated air outside of the biosafety cabinet 100. The exhaust system 110 may include an exhaust filter 120. The biosafety cabinet 100 may also have a supply filter 124 to filter the air entering the work area 112. The position of the exhaust filter 120 and the supply filter 124 may be modified according to the specific use and configuration of the biosafety cabinet 100. HEPA filters may be used for both exhaust filter 120 and the supply filter 124.

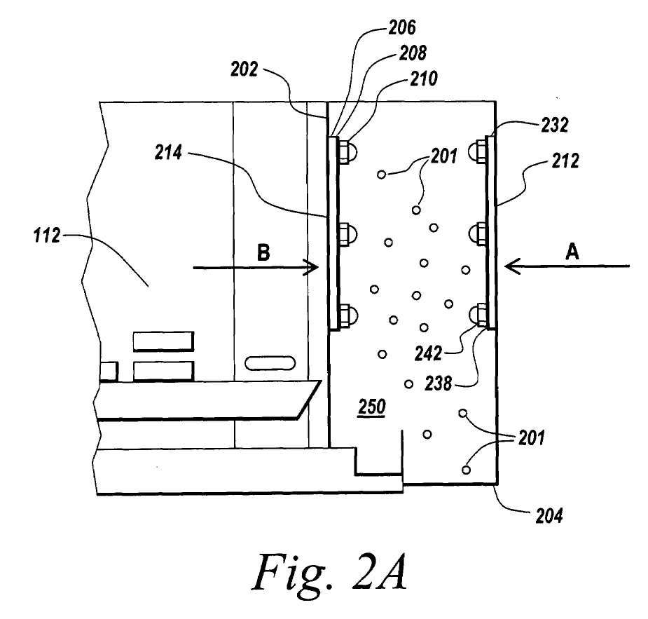

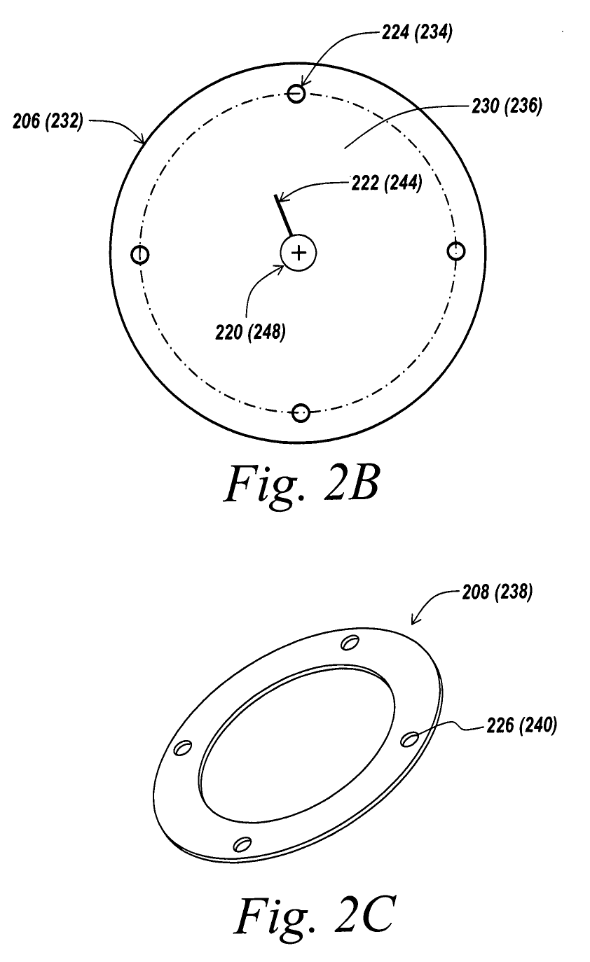

FIG. 2A illustrates a close-up view of a cable port 108 mounted on the biosafety cabinet 100. The biosafety cabinet 100 is built with a double wall configuration having a negative pressure air space 250 between the inner wall 202 and outer wall 204. The provision of negative air pressure in the work area 112 and the air space 250 between the inner wall 202 and the outer wall 204 is known in the art of biosafety cabinets. One of ordinary skill in the art will appreciate that there are a number of different means for generating a negative air pressure space in a confined area, such as the chamber between the inner wall 202 and the outer wall 204. The provision of a negative air pressure is typically achieved with the use of one or more blowers drawing air through the chamber (such as negative pressure air space 250 and work area 112), as would be understood by those of ordinary skill in the art, and thus not further described or illustrated herein.

Continuing with the cable port 108 discussion, an inner wall hole 214 is cut in an inner wall 202 and a second outer wall hole 212 is cut in the outer wall 204. The inner and outer wall holes 212 and 214 may be concentric and may be, for example, of about a 3″ diameter, or another dimension based on the intended use of the cable port 108. The inner wall hole 214 has a cable port gasket 206 and a ring 208 mounted over the inner wall hole 214. The gasket 206 and the ring 208 may be mounted using, for example, a combination 210 of weld studs, a flat washer, lock washer and wing nut, or other known methods for mounting gaskets and rings similarly situated. The gasket 206 and the ring 208 are located in the interior air space between the inner wall 202 and the outer wall 204.

Similar to the inner wall hole 214, the outer wall hole 212 cut in the outer wall 204 has a cable port gasket 232 and a ring 238 mounted over the hole 212. The gasket 232 and the ring 238 may be mounted using, for example, a combination 242 of weld studs, a flat washer, lock washer and wing nut, or other known methods for mounting gaskets and rings similarly situated. The gasket 232 and the ring 238 are located in the interior air space between the inner wall 202 and the outer wall 204.

FIG. 2B illustrates an exemplary inner cable port gasket 206. A hole 220 with a slit 222 is located in the center of a membrane 230 (inner membrane) extending across the inner cable port gasket 206 to permit the passing of small tubing, power, and/or data cables, and the like, into the work area 112 of the biosafety cabinet 100. The inner gasket 206 has a larger outer diameter than the diameter of the inner wall hole 214 cut in the inner wall.

One ordinary skill in the art will appreciate that the outer cable port gasket 232 used in the outer wall 204 of the biosafety cabinet 100 may have the same structure as the inner cable port gasket 206. A hole 248 with a slit 244 is located in the center of a membrane 236 (outer membrane) extending across the outer cable port gasket 232 to permit the passing of small tubing, power, and/or data cables, and the like, into the work area 112 of the biosafety cabinet 100. The outer gasket 232 has a larger outer diameter than the diameter of the outer wall hole 212 cut in the outer wall 204.

FIG. 2C illustrates an exemplary inner ring 208. The inner cable port ring 208 along with the hardware combination 210 holds the inner gasket 206 tightly around its perimeter to the inner wall hole 214. This arrangement prevents air from entering through the perimeter of the inner gasket 206. The inner gasket 206 has small holes 224 positioned closer to the outer diameter of the inner gasket 206. The holes 224 of the inner gasket 206 correspond to the holes 226 of the inner ring 208 to provide access to the combination 210 of weld studs, a flat washer, lock washer and wing nut.

One of ordinary skill in the art will appreciate that the outer ring 238 used in the outer wall 204 of the biosafety cabinet 100 may have the same structure as the inner ring 208 used in the inner wall 202 of the biosafety cabinet 100. The outer cable port ring 238 along with the hardware combination 242 holds the outer gasket 232 tightly around its perimeter to the outer wall hole 212. This arrangement prevents air from entering through the perimeter of the outer gasket 232. The outer gasket 232 has small holes 234 positioned closer to the outer diameter of the outer gasket 232. The holes 234 of the outer gasket 232 correspond to the holes 240 of the outer ring 238 to provide access to the combination 242 of weld studs, a flat washer, lock washer and wing nut.

The negative pressure air space between the inner 202 and outer wall 204 captures particulates 201 in the air that may be attempting to migrate between the two gasket openings when small tubing and/or cables are running through them. The cable port gasket 206, 232 may be made of a soft, flexible material, such as neoprene, that allows the gasket 206, 232 to better surround the small tubing and/or cables running through the gasket 206, 232, thus preventing most air particulates 201 from passing through the gasket 206, 232. As a result, the biosafety cabinet 100 maintains its integrity and contamination control. The material of the gasket 206, 232 needs to form a snug fit around the small tubing and/or cables running through the gasket 206, 232. The main purpose is to create as much of an airtight seal as possible around the small tubing and/or cables. The aperture of the slit 222, 244 located in the center of a membrane 230, 236 extending across the cable port gasket 206, 232 may be designed to fit around a special designed cable, such as a cable with a star, cross, triangular, square or Y-shaped cross-section. Similarly, the width of the slit 222, 244 may be designed according to the shape and number of the small tubing and/or cables that will be run through it. The slit 222, 244 may also have a straight line, a curved line, a wave pattern or a broken line aperture.

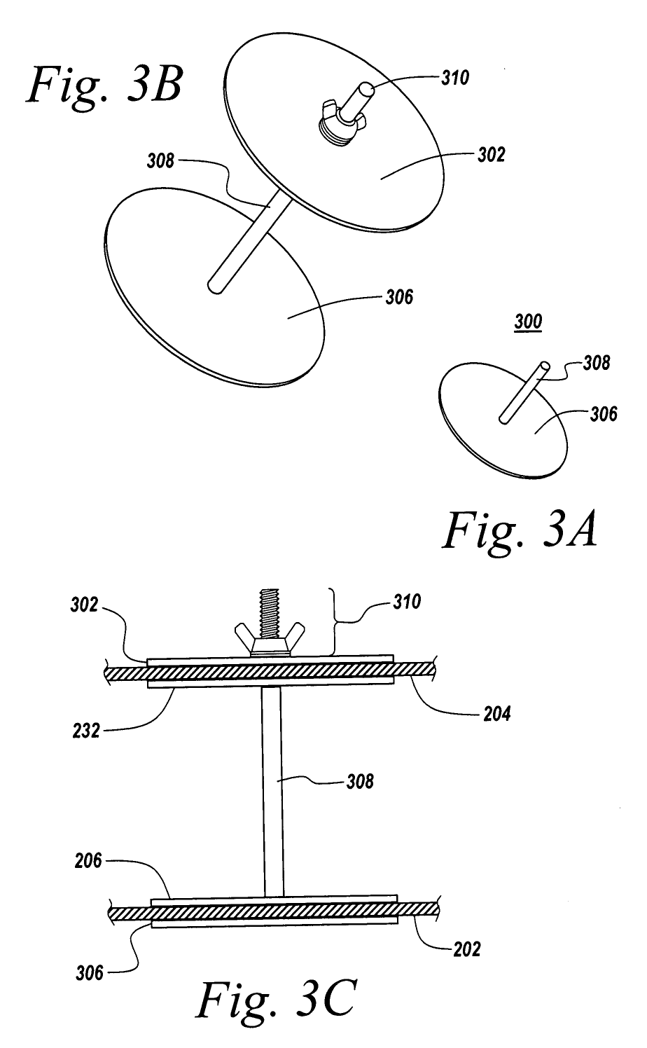

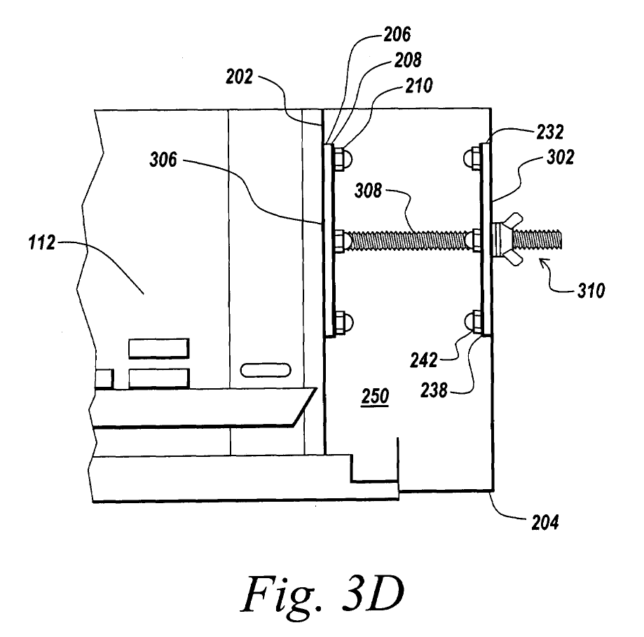

When a cable port 108 is not in use, a cable port plug assembly 300 is provided to cover and occlude both openings in the cable port. In accordance with one embodiment, the cable port plug assembly 300 can be installed without the need for tools. FIGS. 3A-3B illustrate an exemplary cable port plug assembly 300. The cable port plug assembly 300 includes an inside plate 306 coupled with a threaded rod 308. The threaded rod 308 can be tack welded, or otherwise coupled with the inside plate 306.

FIG. 3C illustrates a cable port plug 300 mounted on the cable port gaskets 206, 232. The threaded rod 308 fits through the opening of the inner gasket 206 and the inside plate 306 seals against the surface of the cable port 108 on the inner wall 202 of the cabinet. The inside plate 306 and the threaded rod 308 are placed against the cable port 108 from inside the biosafety cabinet 100. The end of the threaded rod 308 passes though the center of the inner gasket 206 and the outer gasket 232. The outer cable port gasket 232 is covered with an outside plate 302 that fits over the end of the threaded rod 308. In accordance with one embodiment, a hardware combination 310 of a vinyl cap, a lockmaster, a flat washer and a wing nut is placed over the end of the threaded rod 308 to hold the outside plate 302 and thus the cable port plug 300 in place. When mounted, the inside plate 306 seals against the surface of the cable port 108 preventing air from escaping into the port from the interior work area 112 of the cabinet 100. Likewise, the outside plate 302 seals against the surface of the cable port 108 preventing air from outside of the cabinet from entering into the work area 112 through the cable port 108. In the event that some small amounts of air do manage to leak past the inside plate 306 or the outside plate 302, the negative air pressure between the inner wall 202 and the outer wall 204 draws that air down to a filter, thus preventing the air passing completely through the cable port 108. The cable port plug 300 keeps air particulates 201 from entering either end of the cable port 108. As a result, the biosafety cabinet 100 maintains its integrity and contamination control.

FIG. 3D illustrates the side of a biosafety cabinet 100 where cable gaskets 206 and 232 are mounted on the inner wall 202 and on the outer wall 204 of the biosafety cabinet 100, respectively. A cable port plug assembly 300 is mounted on the cable port 108, which is not in use.

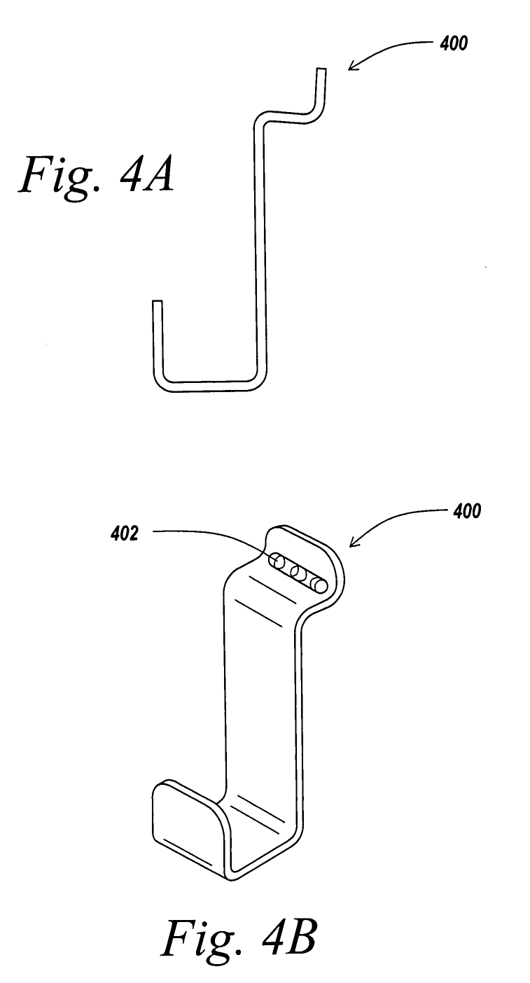

Cable hooks 400 may be installed inside the cabinet work area 112 to keep small tubing and/or cables off the work area 112, and also to support the tubing and/or cables to reduce the amount they may pull on the cable port 108, which could otherwise impact the ability of the cable port 108 to seal around the tubing and/or cables. FIGS. 4A-4B illustrate an exemplary cable hook 400. An exemplary cable hook 400 may include an L-shaped end to hook into an aperture in the wall of the cabinet to mount the cable hook 400. Likewise, other conventional mechanical fastening means can be utilized to position the cable hooks 400 as desired within the cabinet.

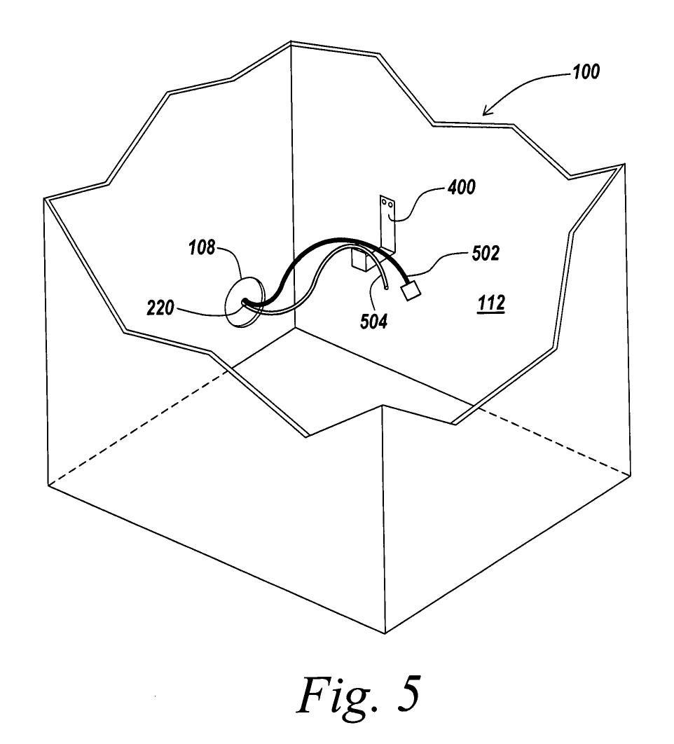

In operation, a user makes use of the cable port 108 to provide tubes, cables, cords, power, or other items to the interior work area 112 of the biosafety cabinet 100 on an as needed basis. The use of the cable port 108 provides an alternative to simply running such items through the lower opening of a door 106 in the view screen 104 area. If the cable port plug assembly 300 is in place, the assembly 300 is first removed to provide access the cable port 108. A user can then pass the desired tubing, cable, and the like through the cable port from either inside the cabinet or outside the cabinet and make any desired connections with devices in the work area 112, and/or with devices or sources outside of the biosafety cabinet 100. FIG. 5 illustrates the cable port 108 with example cables 502 and tubes 504 running therethrough.

With the cables 502 and tubes 504 running through the cable port 108, the slit 222, 244 and the hole 220, 248 provide the membrane 230, 236 with an improved ability to seal around the cables 502 and tubes 504. A cable hook 400 is provided in the cabinet to keep the cables 502 and tubes 504 away from the work area. When the cabinet 100 is in use, there is a negative air pressure maintained within an internal wall chamber 250 between the inner wall 202 and the outer wall 204. The negative air pressure draws air in the direction of arrows A and B from outside of the biosafety cabinet 100 (arrow A) and from the interior work area 112 (arrow B) and then down to a filter location (not shown) to filter the air.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved.

What is claimed is:

1. A biological safety cabinet, comprising:
a housing formed of a plurality of walls defining a workspace chamber having an internal environment therein, the plurality of walls having a double wall structure configuration with an interior wall chamber therebetween;
a door disposed on one wall of the housing having an open position and a closed position, and configured to provide a work access opening providing physical access to the workspace chamber when the door is in the open position and obstruct the work access opening when the door in the closed position; and
a cable port disposed in a wall of the plurality of walls defining the workspace chamber, the cable port comprising:
an opening through the double wall structure leading from an external environment through the interior wall chamber to the internal environment;
an outer flexible membrane disposed on an outside wall of the double wall structure of the housing and covering the opening through the double wall structure;
an inner flexible membrane disposed on an inside wall of the double wall structure of the housing and covering the opening through the double wall structure;
at least one slit disposed in the outer flexible membrane configured to permit a cable to pass through the at least one slit in the outer flexible membrane;
at least one slit disposed in the inner flexible membrane configured to permit a cable to pass through the at least one slit in the inner flexible membrane;
wherein the cable port at least substantially occludes airflow from the internal environment through to the external environment.

2. The biological safety cabinet of claim 1, wherein the double wall configuration comprises an inner wall and an outer wall with the interior wall chamber therebetween.

3. The biological safety cabinet of claim 2, wherein the double wall configurations maintain a negative pressure air space in the interior wall chamber between the inner wall and the outer wall when the cabinet is in operation.

4. The biological safety cabinet of claim 1, further comprising:
a first ring disposed on the outer flexible membrane to tightly attach the outer flexible membrane to the double wall structure; and
a second ring disposed on the inner flexible membrane to tightly attach the inner flexible membrane to the double wall structure.

5. The biological safety cabinet of claim 1, further comprising a cable port plug to cover the cable port when the cable port is not in use.

6. The biological safety cabinet of claim 1, further comprising a plurality of cable hooks disposed on one or more walls of the workspace chamber, wherein the plurality of cable hooks carry a plurality of cables.

7. The biological safety cabinet of claim 1, wherein the door is slidably mounted within the housing.

8. The biological safety cabinet of claim 1, wherein the door comprises a visibility screen.

9. The biological safety cabinet of claim 1, further comprising an exhaust filter disposed to filter air exhausted from the workspace chamber.

10. The biological safety cabinet of claim 1, further comprising a supply filter disposed to filter airflow entering inside the workspace chamber.

11. The biological safety cabinet of claim 1, wherein the at least one slit disposed in the outer flexible membrane is concentric with the at least one slit disposed in the inner flexible membrane.

12. The biological safety cabinet of claim 1, wherein the workspace chamber further comprises a germicidal light source that generates germicidal light in the internal environment of the workspace chamber.

13. The biological safety cabinet of claim 12, wherein when the door is in the closed position, the germicidal light is fully contained in the internal environment of the workspace chamber.

14. A method of controlling contamination, the method comprising:
providing a biological safety cabinet, comprising:
a housing formed of a plurality of walls defining a chamber having an internal environment inside the chamber, the plurality of walls having a double wall structure;
a door disposed on one wall of the housing having an open position and a closed position, and configured to provide a work access opening providing physical access to the chamber when the door is in the open position and obstruct the work access opening when the door in the closed position; and
a cable port disposed in a wall of the plurality of walls defining the chamber, the cable port comprising:
an opening through the double wall structure leading from an external environment through to the internal environment;
an outer flexible membrane disposed on an outside wall of the double wall structure of the housing and covering the opening through the double wall structure;
an inner flexible membrane disposed on an inside wall of the double wall structure of the housing and covering the opening through the double wall structure;
at least one slit disposed in the outer flexible membrane configured to permit a cable to pass through the at least one slit in the outer flexible membrane;
at least one slit disposed in the inner flexible membrane configured to permit a cable to pass through the at least one slit in the inner flexible membrane;
wherein the cable port at least substantially occludes airflow from the internal environment to the external environment;
providing a cable port gasket mounted on the cable port, the cable port gasket keeping air particulates from entering the chamber.

15. The method of claim 14 further comprising:
providing a cable port plug;
covering the cable port with the cable port plug when the cable port is not in use, wherein the cable port plug keeps air particulates from entering the cable port and the chamber.

16. The method of claim 14, wherein the double wall configuration comprises an inner wall and an outer wall.

17. The method of claim 16, wherein the double wall configurations maintain a negative pressure air space between the inner wall and the outer wall when the cabinet is in operation.

18. The method of claim 17, further comprising capturing particulates in air using the negative pressure air space.

19. The method of claim 14, wherein the chamber further comprises a germicidal light source that generates germicidal light in the internal environment of the chamber.

20. The biological safety cabinet of claim 19, wherein when the door is in the closed position, the germicidal light is fully contained in the internal environment of the chamber.
